(19) United States
(12) Patent Application Publication
(10) Pub. No.: US 2024/0155715 A1
(43) Pub. Date: May 9, 2024

(54) MULTI-LINK COMMUNICATIONS WITH MILLIMETER WAVE (MMWAVE) LINK AND NON-MMWAVE LINK

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/382,454

(22) Filed: Oct. 20, 2023

Related U.S. Application Data
(60) Provisional application No. 63/380,362, filed on Nov. 3, 2022.

(51) Int. Cl. H04W 76/15

(52) U.S. Cl. CPC H04W 76/15; H04W 84/12

(57) ABSTRACT

Embodiments of a method and apparatus for wireless communications are disclosed. In an embodiment, a wireless multi-link device (MLD) includes a controller configured to generate control or management information regarding a millimeter wave (mmWave) link between the wireless MLD and a second wireless MLD and a wireless transceiver configured to transmit the control or management information regarding the mmWave link to the second wireless MLD through the mmWave link or a non-mmWave link between the wireless MLD and the second wireless MLD.

### CROSS-REFERENCE TO RELATED APPLICATIONS

This application is entitled to the benefit of U.S. Provisional Pa Application Ser. No. 63/380,362, filed on Oct. 20, 2022, which is incorporated by reference herein.

### BACKGROUND

In multi-link communications, an access point (AP) multi-link device (MLD) can transmit various types of information using different transmission techniques to a non-AP MLD. For example, a wireless AP MLD may wirelessly transmit data to one or more wireless stations in a non-AP MLD through one or more wireless communications links, such as a millimeter wave (mmWave) link and a non-mmWave link. To facilitate the proper data transmission within a multi-link communications system having an mmWave link and a non-mmWave link, there is a need for multi-link communications technology that can efficiently convey communications signaling information, for example, information related to data, communications links, and/or multi-link devices (e.g., operation and/or capability parameters of multi-link devices) within the multi-link communications system.

### SUMMARY

Embodiments of a method and apparatus for wireless communications are disclosed. In an embodiment, a wireless multi-link device (MLD) includes a controller configured to generate control or management information regarding a millimeter wave (mmWave) link between the wireless MLD and a second wireless MLD and a wireless transceiver configured to transmit the control or management information regarding the mmWave link to the second wireless MLD through the mmWave link or a non-mmWave link between the wireless MLD and the second wireless MLD. Other embodiments are also disclosed.

In an embodiment, the wireless MLD includes an access point (AP) MLD that includes a wireless AP, the wireless AP includes the controller and the wireless transceiver, and the second wireless MLD includes a non-AP MLD that includes a non-AP station (STA).

In an embodiment, the non-mmWave link includes one of a 2.4 Gigahertz (GHz) link, a 5 GHz link, or a 6 GHz link, and the mmWave link includes a 45 GHz link or a 60 GHz link.

In an embodiment, the wireless transceiver is further configured to transmit the control or management information regarding the mmWave link to the second wireless MLD through the non-mmWave link between the wireless MLD and the second wireless MLD.

In an embodiment, the controller is further configured to generate a broadcast frame that contains the control or management information regarding the mmWave link, and the wireless transceiver is further configured to transmit the broadcast frame to the second wireless MLD through the non-mmWave link between the wireless MLD and the second wireless MLD.

In an embodiment, the control or management information regarding the mmWave link includes link connection establishment information regarding the mmWave link.

In an embodiment, the control or management information regarding the mmWave link includes mmWave sounding announcement information regarding the mmWave link that initiates a sector sweep training between the wireless MLD and the second wireless MLD.

In an embodiment, the mmWave sounding announcement information regarding the mmWave link includes a null data packet announcement (NDPA) or a request to send (RTS).

In an embodiment, the wireless transceiver is further configured to transmit the control or management information regarding the mmWave link to the second wireless MLD through the mmWave link between the wireless MLD and the second wireless MLD.

In an embodiment, the control or management information regarding the mmWave link includes a measurement related frame of the mmWave link.

In an embodiment, the controller is further configured to generate a unicast frame that contains the control or management information regarding the mmWave link, and the wireless transceiver is further configured to transmit the unicast frame through the mmWave link.

In an embodiment, the wireless MLD includes a non-AP MLD that includes a non-AP STA, the non-AP station includes the controller and the wireless transceiver, and the second wireless MLD includes an AP MLD that includes a wireless AP.

In an embodiment, the wireless MLD is compatible with an Institute of Electrical and Electronics Engineers (IEEE) 802.11 protocol.

In an embodiment, a wireless AP of an AP MLD includes a controller configured to generate control or management information regarding an mmWave link between the AP MLD and a non-AP MLD, where the mmWave link includes a 45 Gigahertz (GHz) link or a 60 GHz link, and a wireless transceiver configured to transmit the control or management information regarding the mmWave link to the non-AP MLD through a non-mmWave link between the AP MLD and the non-AP MLD, where the non-mmWave link includes one of a 2.4 GHz link, a 5 GHz link, or a 6 GHz link.

In an embodiment, the control or management information regarding the mmWave link includes link connection establishment information regarding the mmWave link.

In an embodiment, the control or management information regarding the mmWave link includes mmWave sounding announcement information regarding the mmWave link that initiates a sector sweep training between the AP MLD and the non-AP MLD.

In an embodiment, the mmWave sounding announcement information regarding the mmWave link includes an NDPA or an RTS.

In an embodiment, the wireless AP is compatible with an IEEE 802.11 protocol.

In an embodiment, a method for wireless communications involves at a first wireless MLD, generating control or management information regarding an mmWave link between the first wireless MLD and a second wireless MLD and from the first wireless MLD, transmitting the control or management information regarding the mmWave link to the second wireless MLD through the mmWave link or a non-mmWave link between the first wireless MLD and the second wireless MLD.

In an embodiment, the non-mmWave link includes one of a 2.4 GHz link, a 5 GHz link, or a 6 GHz link, and the mmWave link includes a 45 GHz link or a 60 GHz link.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system in accordance with an embodiment of the invention.

FIG. 2 depicts an example control Identifier (ID) subfield value table.

FIG. 3 depicts a frame exchange sequence of an mmWave sector sweep training (also referred to sector sweep) as initiated by a non-mmWave link in accordance with an embodiment of the invention.

FIG. 4 depicts a frame exchange sequence of an mmWave sector sweep initiated by a non-mmWave link in accordance with an embodiment of the invention.

FIG. 5 depicts a frame exchange sequence of an mmWave sector sweep initiated by a non-mmWave link in accordance with an embodiment of the invention.

FIG. 6 depicts a frame exchange sequence of an mmWave sector sweep initiated by a non-mmWave link in accordance with an embodiment of the invention.

FIG. 7 depicts a frame exchange sequence of an mmWave sector sweep initiated by a non-mmWave link in accordance with an embodiment of the invention.

FIG. 8 depicts a frame exchange sequence of an mmWave sector sweep initiated by a non-mmWave link in accordance with an embodiment of the invention.

FIG. 9 depicts a frame exchange sequence of an mmWave sector sweep initiated by a non-mmWave link in accordance with an embodiment of the invention.

FIG. 10 depicts a frame exchange sequence of an mmWave sector sweep initiated by a non-mmWave link in accordance with an embodiment of the invention.

FIG. 11 depicts a frame exchange sequence of sounding rejection by a responder in accordance with an embodiment of the invention.

FIG. 12 depicts a wireless device in accordance with an embodiment of the invention.

FIG. 13 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Institute of Electrical and Electronics Engineer (IEEE) 802.11 communication protocol.

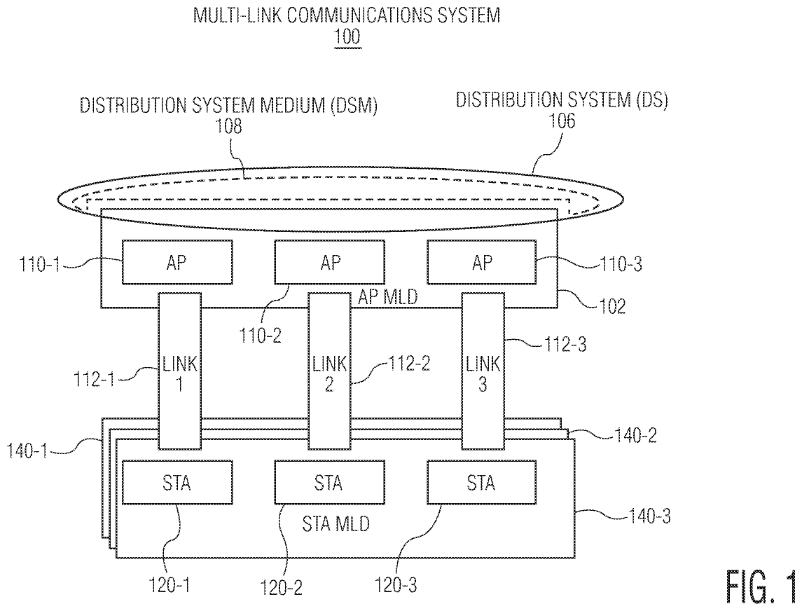

FIG. 1 depicts a multi-link (ML) communications system 100 in accordance with an embodiment of the invention. In the embodiment depicted in FIG. 1, the multi-link communications system includes at least one AP multi-link device (MLD) 102, and one or more non-AP multi-link devices, which are, for example, implemented as station (STA) MLDs 104-1, 104-2, 104-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one wireless local area network (WLAN) communications protocol (e.g., at least one IEEE 802.11 protocol). For example, the APs 110-1, 110-2, 110-3 may be wireless APs compatible with at least one WLAN communications protocol (e.g., at least one IEEE 802.11 protocol).

In some embodiments, an AP MLD (e.g., the AP MLD 102) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 110-1, 110-2, 110-3 of the AP MLD 104 operates in different frequency bands. For example, at least one of the APs 110-1, 110-2, 110-3 of the AP MLD 104 operates in an Extremely High Frequency (EHF) band or the “millimeter wave (mmWave)” frequency band. In some embodiments, the mmWave frequency band is a frequency band between 20 Gigahertz (GHz) and 300 GHz. For example, the mmWave frequency band is a frequency band above GHz, e.g., a 60 GHz frequency band. For example, the AP 110-1 may operate at 6 Gigahertz (GHz) band (e.g., in a 320 MHz (one million hertz) Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 60 GHz band (e.g., a 160 MHz BSS operating channel or other suitable BSS operating channel). In the embodiment depicted in FIG. 1, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to a wireless AP MLD, such as, the AP MLD 102. For example, the STA MLD 104-1 (e.g., at least one of the non-AP STAs 120-1, 120-2, 120-3) may be implemented in a laptop, a desktop personal computer (PC), a mobile phone, or other communications device that supports at least one WLAN communications protocol. In some embodiments, the STA MLD and its affiliated STAs 120-1, 120-2, 120-3 are compatible with at least one IEEE 802.11 protocol. In some embodiments, each of the non-AP STAs 120-1, 120-2, 120-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface. In some embodiments, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 104-1 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. For example, the STA 120-1 may operate at 6 GHz band (e.g., in a 320 MHz (one million hertz) BSS operating channel or other suitable BSS operating channel), the STA 120-2 may operate at 5 GHz band (e.g., a 160 MHz BSS operating channel or other suitable BSS operating channel), and the STA 120-3 may operate at 60 GHz band (e.g., a 160 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 or 104-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In the embodiment depicted in FIG. 1, the communications links 112-1, 112-2, 112-3 between the AP MLD and the STA MLD 104-1 involve at least one mmWave link. For example, the communications links 112-1, 112-2, 112-3 between the AP MLD 102 and the STA MLD 104-1 include an mmWave link (e.g., a 45/60 GHz link) between an AP of the AP MLD 102 and an STA of the STA MLD 104-1 operating in an mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, 112-3 between the AP MLD 102 and the STA MLD 104-1 include two mmWave links (e.g., 45/60 GHz links) between APs of the AP MLD 102 and STAs of the STA MLD 104-1 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band). The control and management of an mmWave link, for example, a 45 GHz/60 GHz link may be performed in a non-mmWave link, for example, a 2.4 GHz, 5 GHz, or 6 GHz link. For example, the association of a non-AP MLD with an mmWave link can be done through a non-mmWave MHz link. However, beaconing and channel switch can be challenging for a MLD system with one or more mmWave links.

Some management/control information may be unicast while some management/control information may be broadcast. Some management/control information may be used within the transmit opportunity (TXOP) that the information/payload data is transmitted. Some management/control information may require the response while some management/control information may not require the response. In some cases, the response is required with a specific responding time (e.g., a short interframe space (SIFS)). Some management/control information may be used for measurement.

Control/management information may be or may not be transmitted in an mmWave link. In some embodiments, when a frame exchange is for link connection establishment and/or the control of the sounding for antenna gain, the frame exchange is done in a non-mmWave link (e.g., a 2.4/5/6 GHz band link). In some embodiments, if a frame exchange is required (e.g., a handshake for initiating sounding, sounding result feedback) before figuring out the antenna gain through sounding, the frame exchange is done in a non-mmWave link (e.g., a 2.4/5/6 GHz band link). One exception may be that if two devices are close enough to do the frame exchange by using lowest Modulation Coding Scheme (MCS) in an mmWave link (e.g., a 45 GHz link or a 60 GHz link), the frame exchange can be done in the mmWave link. In some embodiments, when the control/management information (e.g., the BSS color change and/or the channel switch) of an mmWave link (e.g., a 45 GHz link or a 60 GHz link) is carried in a broadcast frame, the control/management information is transmitted in a non-mmWave link (e.g., a 2.4/5/6 GHz band link) supported by a corresponding AP MLD with one exception that the beacon of the mmWave link is transmitted in the mmWave link. In a first option, when the control/management information (e.g., of an mmWave link (e.g., a 45 GHz link or a 60 GHz link)) is carried in a unicast frame, the control/management information is transmitted in a non-mmWave link (e.g., a 2.4/5/6 GHz band link). In a second option, when the control/management information of an mmWave link (e.g., a 45 GHz link or a 60 GHz link) is carried in a unicast frame, the control/management information is transmitted in either the mmWave link or a non-mmWave link (e.g., a 2.4/5/6 GHz band link). For example, the information of power save (e.g., power management mode, awake/doze state) may be transmitted in the mmWave link and other links. In another example, the control/management information of an mmWave link may include a block acknowledgement (BA) and/or Target Wake Time (TWT) negotiation etc. In some embodiments, when the mmWave responding information is required SIFS after the reception of a soliciting frame, the related frame exchange is done in an mmWave link. For example, one of such frame exchange is the responding BA solicited by A-MPDU (Aggregated MAC Protocol Data Unit) in an mmWave link.

Some embodiments of mmWave link measurement are described as follows. In some embodiments, a measurement related frame (e.g., sounding, transmit power control (TPC), ranging, and/or sensing) of an mmWave link (e.g., a 45 GHz link or a 60 GHz link) is transmitted in the mmWave link only. The control frame that initiates the measurement may be transmitted in a non-mmWave link (e.g., for sounding) or an mmWave link (e.g., for ranging, sensing). In a first option, the measurement result (e.g., the measurement result report) of an mmWave link is transmitted in the mmWave link only. In a second option, the measurement result (e.g., the measurement result report) of an mmWave link is transmitted in a non-mmWave link only. In a third option, the measurement result (e.g., the measurement result report) of an mmWave link is transmitted in either an mmWave link or a non-mmWave link.

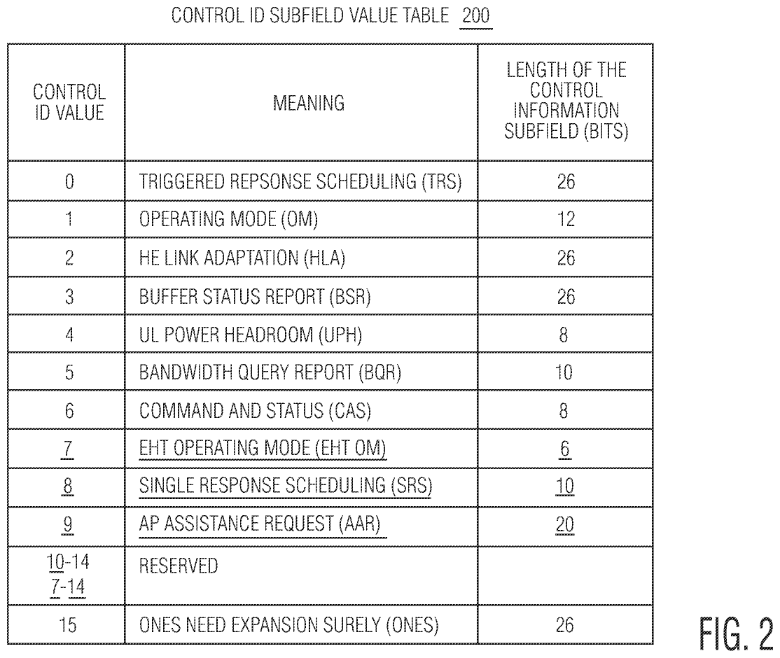

FIG. 2 depicts an example control Identifier (ID) subfield value table 200. In the example control ID subfield value table 200 depicted in FIG. 2, subfield values, such as, triggered response scheduling (TRS), operating mode (OM), High Efficiency (HE) link adaptation (HLA), Buffer status report (BSR), Uplink (UL) power headroom (UPH), buffer status report (BQR), command and status (CAS), Extremely High Throughput (EHT) operating mode (EHT OM), Single response scheduling (SRS), AP assistance request (AAR), and corresponding length are listed. In some embodiments, the Control Information subfield in a TRS Control subfield contains TRS information for soliciting a HE/EHT trigger-based (TB) physical layer protocol data unit (PPDU) that follows an HE/EHT multi-user (MU) PPDU, HE single user (SU) PPDU or HE/EHT extended range (ER) SU PPDU carrying the control subfield. In some embodiments, the Control Information subfield in an OM Control subfield contains information related to the OM change (bandwidth (BW), number of spatial streams (Nss) sets, etc.) of the STA transmitting the frame containing this information. In some embodiments, the Control Information subfield in an HLA Control subfield contains information related to the HLA procedure. In some embodiments, the Control Information subfield in a BSR Control subfield contains buffer status information used for UL MU operation. In some embodiments, the Control Information subfield in an UPH Control subfield contains the UPH used for power pre-correction. In some embodiments, the Control Information subfield in a BQR Control subfield contains the BQR used for bandwidth query report operation to assist HE MU transmission. In some embodiments, the Control Information subfield in a CAS Control subfield contains the CAS control (Reverse Direction (RD) operation etc.).

In some embodiments, triggered response scheduling (TRS) for multi-user (MU) operation is carried or transmitted in an mmWave link if MU operation is supported in the mmWave link since it solicits responding PPDU with SIFS inter-frame space. In some embodiments, operating mode (OM) for the operating mode change (e.g., bandwidth (BW), Nss, and/or maximal MCS) of an mmWave link can be transmitted in the mmWave link or a non-mmWave link. In some embodiments, HE link adaptation (HLA) for an mmWave link is carried in the mmWave link. In some embodiments, the transmission of HLA in a non-mmWave link needs the redefinition of the field to give room for cross-link indication. In some embodiments, because buffer status report (BQR) needs the immediate carrier sensing (CA) result, BQR for an mmWave link needs to be transmitted in the mmWave link. BSR for an mmWave link may be transmitted in the mmWave link or a non-mmWave link. However, it may be mainly used for TB operation or low latency support with the assumption that the low latency related information is added to BSR, e.g., 1) the lifetime of the first frame in the queue and the lifetime of the last frame being reported by the BSR, 2) requested medium time instead of the buffer size being reported. In some embodiments, uplink power headroom (UPH) is carried in TB PPDU solicited by a trigger frame. If an mmWave link supports TB PPDU, the UPH for the mmWave link is carried in the mmWave link only. In some embodiments, the command and status (CAS) of an mmWave link can only be transmitted in the mmWave link since it indicates the PPDU type for PSRT (parameterized spatial reuse transmission) or requires SIFS operation for Reverse Direction (RD). Single response scheduling (SRS) may not be needed since it solves the problem of Nonsimultaneous transmit and receive (NSTR) operation. SRS can only be transmitted in the mmWave link since it provides the parameters for the responding frame with SIFS inter-frame space. AP assistance request (AAR) may not be needed since it solves the problem of NSTR/Enhanced Multilink Single-Radio (EMLSR) operation with the exception that the NSTR mmWave links are allowed in a non-AP MLD in which the AAR is transmitted in the mmWave link.

In some embodiments, an AP/STA in an mmWave link may change its operating mode (e.g., BW, transmitter (Tx) Nss, and/or receiver (Rx) Nss). In a first option, the operating mode change of an mmWave link is done through the mmWave link only. The HE OM Control with redefined subfield (e.g., the channel unit is 80 MHz or 160 MHz instead of 20 MHz) or a HE Control with new Control ID. In a second option, the operating mode change of an mmWave link is done through the mmWave link or a non-mmWave link. The HE OM Control may be with redefined subfield (e.g., the channel unit is 80 MHz or 160 MHz instead of 20 MHz) or a HE Control with new Control ID. A new HE Control may be defined to indicate the applied link of the cross-link OM.

In some embodiments, the BSR of an mmWave link is done through the mmWave link only, which may be required for TB operation, low latency support and/or triggered TXOP sharing. For triggered TXOP sharing, the soliciting of non-AP MLD's medium time requirement may also be needed even if the TB PPDU is not supported. The solicited BSR of an mmWave link needs to be transmitted in the mmWave link since most likely the medium time requirement is used by the AP right away in the same TXOP.

In some embodiments, the BSR of an mmWave link is done through the mmWave link or a non-mmWave link. A new HE Control may be defined to indicate the applied link of the cross-link BSR. In some embodiments, when an AP and a corresponding STA cannot reach each other in an mmWave link without sounding for antenna gain, the mmWave link sounding is initiated in a non-mmWave link. In some embodiments, when an AP and a corresponding STA can reach each other in an mmWave link without sounding, the mmWave link sounding is initiated in a non-mmWave link or the mmWave link.

In some embodiments, the updated null data packet announcement (NDPA) is used for the mmWave sounding and indicates whether the sounding is done through cross-link or not. In some embodiments, a special STA information field is defined to indicate whether the cross-link sounding is requested or not, and the link ID of mmWave link in the cross-link sounding is requested. In some embodiments, the link ID is used since an MLD may include more than one mmWave links. In some embodiments, in a STA Info field, one reserved bit is used to indicate the cross-link sounding announcement. The STA Info field may be redesigned. The sector number being trained can be announced in NDPA or in an mmWave link's capabilities element. In some embodiments, a new control frame is defined for Ultra High Reliability (UHR) NDPA of cross-link sounding.

Some examples of frame exchange sequence of an mmWave sector sweep training (also referred to sector sweep) are described below. In some embodiments, beamforming by sector sweeping is used to determine a transmission beamforming pattern to be applied by a first wireless device when transmitting data to a second wireless device. For example, the first wireless device can transmit training packets to the second wireless device, where the first wireless device can apply a different beamforming pattern when transmitting each training packet. The second device generally determines which of the training packets had the highest quality (e.g., having the highest signal-to-noise ratio (SNR) and/or the lowest bit error rate (BER) and notifies the first wireless device, which can then utilize the transmission beamforming pattern that yielded the highest quality packet. Similarly, to determine a reception beamforming pattern to be applied by the first wireless device when receiving data from the second wireless device, the second wireless device transmits training packets to the first wireless device, and the first wireless device applies a different beamforming pattern when receiving each training packet. The first wireless device may determine which of the training packets has the highest quality and utilize the reception beamforming pattern that yields the highest quality packet.

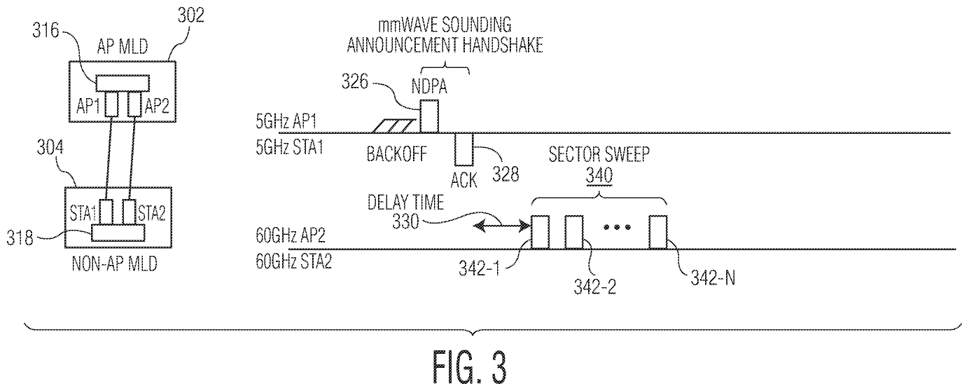

FIG. 3 depicts a frame exchange sequence of an mmWave sector sweep training (also referred to sector sweep) initiated by a non-mmWave link in accordance with an embodiment of the invention. In the embodiment depicted in FIG. 3, frames are exchanged between an AP MLD 302, which includes a common MAC controller 316 and two wireless APs AP1, AP2, and a non-AP MLD 304, which includes a common MAC controller 318 and two wireless STAs STA1, STA2. In some embodiments, the common MAC controller 316 implements upper layer MAC functionalities (e.g., beaconing, association establishment, reordering of frames, etc.) of the AP MLD 302 and a link specific part of the AP MLD 302, i.e., AP1, AP2, implements lower layer MAC functionalities (e.g., backoff, frame transmission, frame reception, etc.) of the AP MLD 302. In some embodiments, the common MAC controller 318 implements upper layer MAC functionalities (e.g., association establishment, reordering of frames, etc.) of the non-AP MLD 304 and a link specific part of the non-AP MLD 304, i.e., STA1, STA2, implements lower layer MAC functionalities (e.g., backoff, frame transmission, frame reception, etc.) of the non-AP MLD 304. The AP MLD 302 depicted in FIG. 3 is an embodiment of the AP MLD 102 depicted in FIG. 1. However, the AP MLD 102 depicted in FIG. 1 is not limited to the embodiment shown in FIG. 3. In addition, the non-AP MLD 304 depicted in FIG. 3 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 3. In the embodiment depicted in FIG. 3, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 302 is shown in FIG. 3 as including two APs, other embodiments of the AP MLD 302 may include fewer than two APs or more than two APs. In addition, although the non-AP MLD 304 is shown in FIG. 3 as including two non-AP STAs, other embodiments of the non-AP MLD 304 may include fewer than two non-AP STAs or more than two non-AP STAs. In the frame exchange sequence depicted in FIG. 3, after a backoff period expires (i.e., backoff counter becomes zero), AP1 transmits an NDPA 326 to STA1 through the non-mmWave link (e.g., a 5 GHz band link) between AP1 and STA1 and the NDPA 326 is acknowledged by an acknowledgement (Ack) 328 from STA1. The beamformer and the beamformee (e.g., AP2 and STA2, respectively) negotiate a delay time 330 required between the end of frame exchange of the NDPA/ACK and the start of sounding in an mmWave link (e.g., a 60 GHz band link) between AP2 and STA2. The negotiated time and the end time of NDPA frame exchange decide when the sounding in the mmWave link starts. After the delay time 330, both AP2 and STA2 on the mmWave link are ready to do the sounding such that a sector sweep 340 with a number of training sequences 342-1, . . . , 342-N, where N is a positive integer, is communicated or conducted from AP2 to STA2 through the mmWave link (e.g., a 60 GHz band link) between AP2 and STA2. In another embodiment, the AP MLD and the non-AP MLD negotiate the padding time where the NDPA includes the padding field or the PPDU that carries the NDPA includes the padding through the other method (e.g., the MPDU Delimiters after the NDPA frame) for AP2 and STA2 to prepare the sounding within the additional padding time. With such arrangement, SIFS after the PPDU that carries the Ack 328 solicited by NDPA 326, the sector sweep 340 will start.

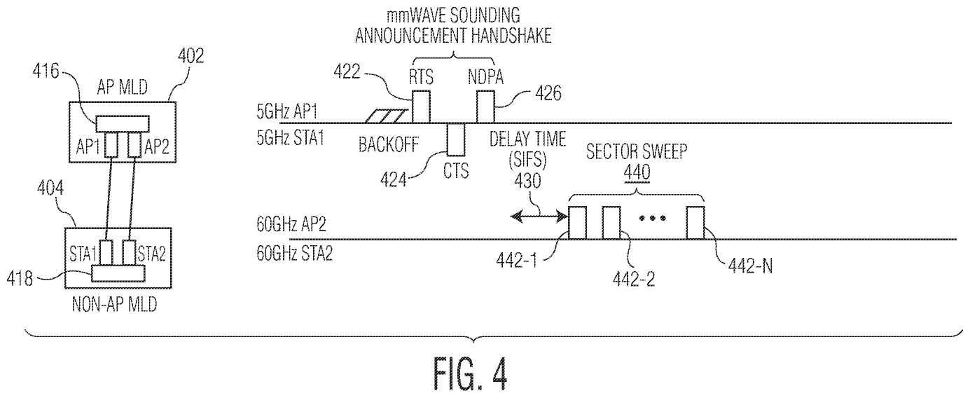

FIG. 4 depicts a frame exchange sequence of an mmWave sector sweep initiated by a non-mmWave link in accordance with an embodiment of the invention. In the embodiment depicted in FIG. 4, frames are exchanged between an AP MLD 402, which includes a common MAC controller 416 and two wireless APs AP1, AP2, and a non-AP MLD 404, which includes a common MAC controller 418 and two wireless STAs STA1, STA2. In some embodiments, the common MAC controller 416 implements upper layer MAC functionalities (e.g., beaconing, association establishment, reordering of frames, etc.) of the AP MLD 402 and a link specific part of the AP MLD 402, i.e., AP1, AP2, implements lower layer MAC functionalities (e.g., backoff, frame transmission, frame reception, etc.) of the AP MLD 402. In some embodiments, the common MAC controller 418 implements upper layer MAC functionalities (e.g., association establishment, reordering of frames, etc.) of the non-AP MLD 404 and a link specific part of the non-AP MLD 404, i.e., STA1, STA2, implements lower layer MAC functionalities (e.g., backoff, frame transmission, frame reception, etc.) of the non-AP MLD 404. The AP MLD 402 depicted in FIG. 4 is an embodiment of the AP MLD 102 depicted in FIG. 1. However, the AP MLD 102 depicted in FIG. 1 is not limited to the embodiment shown in FIG. 4. In addition, the non-AP MLD 404 depicted in FIG. 4 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 4. In the embodiment depicted in FIG. 4, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 402 is shown in FIG. 4 as including two APs, other embodiments of the AP MLD 402 may include fewer than two APs or more than two APs. In addition, although the non-AP MLD 404 is shown in FIG. 4 as including two non-AP STAs, other embodiments of the non-AP MLD 404 may include fewer than two non-AP STAs or more than two non-AP STAs. In the frame exchange sequence depicted in FIG. 4, Request to send (RTS)/clear to send (CTS) is required by a beamformer transmitting an NDPA. Specifically, after a backoff period (i.e., backoff counter becomes zero), AP1 transmits an RTS 422 to STA1 through the non-mmWave link (e.g., a 5 GHz band link) between AP1 and STA1 and STA1 transmits a CTS 424 to AP1 through the non-mmWave link (e.g., a 5 GHz band link) between AP1 and STA1. Subsequently, AP1 transmits an NDPA 426 to STA1 through the non-mmWave link (e.g., a 5 GHz band link) between AP1 and STA1. The beamformer and the beamformee (e.g., AP2 and STA2, respectively) negotiate a delay time 430 required between the end of frame exchange of the NDPA/ACK and the start of sounding in an mmWave link (e.g., a 60 GHz band link) between AP2 and STA2. The negotiated time and the end time of NDPA frame exchange decide when the sounding in the mmWave link starts. After the delay time 430, both AP2 and STA2 on the mmWave link are ready to do the sounding such that a sector sweep 440 with a number of training sequences 442-1, . . . , 442-N, where N is a positive integer, is communicated or conducted from AP2 to STA2 through the mmWave link (e.g., a 60 GHz band link) between AP2 and STA2. In another embodiment, the AP MLD and the non-AP MLD negotiate the padding time where the NDPA includes the padding field or the PPDU that carries the NDPA includes the padding through the other method (e.g., the MPDU Delimiters after the NDPA frame) for AP2 and STA2 to prepare the sounding within the additional padding time. With such arrangement, SIFS after the PPDU that carries the NDPA 426, the sector sweep 440 will start.

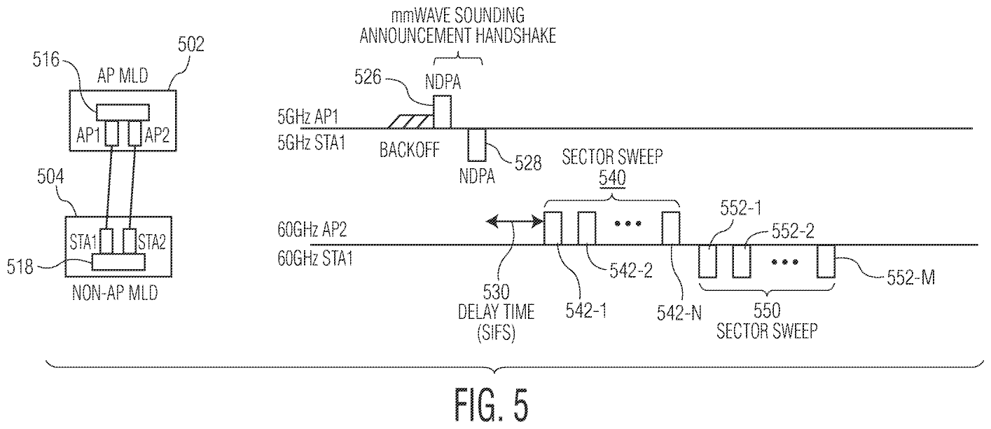

FIG. 5 depicts a frame exchange sequence of an mmWave sector sweep initiated by a non-mmWave link in accordance with an embodiment of the invention. In the embodiment depicted in FIG. 5, frames are exchanged between an AP MLD 502, which includes a common MAC controller 516 and two wireless APs AP1, AP2, and a non-AP MLD 504, which includes a common MAC controller 518 and two wireless STAs STA1, STA2. In some embodiments, the common MAC controller 516 implements upper layer MAC functionalities (e.g., beaconing, association establishment, reordering of frames, etc.) of the AP MLD 502 and a link specific part of the AP MLD 502, i.e., AP1, AP2, implements lower layer MAC functionalities (e.g., backoff, frame transmission, frame reception, etc.) of the AP MLD 502. In some embodiments, the common MAC controller 518 implements upper layer MAC functionalities (e.g., association establishment, reordering of frames, etc.) of the non-AP MLD 504 and a link specific part of the non-AP MLD 504, i.e., STA1, STA2, implements lower layer MAC functionalities (e.g., backoff, frame transmission, frame reception, etc.) of the non-AP MLD 504. The AP MLD 502 depicted in FIG. 5 is an embodiment of the AP MLD 102 depicted in FIG. 1. However, the AP MLD 102 depicted in FIG. 1 is not limited to the embodiment shown in FIG. 5. In addition, the non-AP MLD 504 depicted in FIG. 5 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 5. In the embodiment depicted in FIG. 5, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 502 is shown in FIG. 5 as including two APs, other embodiments of the AP MLD 502 may include fewer than two APs or more than two APs. In addition, although the non-AP MLD 504 is shown in FIG. 5 as including two non-AP STAs, other embodiments of the non-AP MLD 504 may include fewer than two non-AP STAs or more than two non-AP STAs. In the frame exchange sequence depicted in FIG. 5, after receiving an NDPA frame from an initiator, a responder responds with another NDPA to announce the responder's sector sweep. Specifically, after a backoff period (i.e., backoff counter becomes zero), AP1 transmits an NDPA 526 to STA1 through the non-mmWave link (e.g., a 5 GHz band link) between AP1 and STA1 and STA1 transmits an NDPA 528 to AP1 through the non-mmWave link (e.g., a 5 GHz band link) between AP1 and STA1. The beamformer and the beamformee (e.g., AP2 and STA2, respectively) negotiate a delay time 530 required between the end of frame exchange of the NDPA 526 and the start of sounding in an mmWave link (e.g., a 60 GHz band link) between AP2 and STA2. The negotiated time and the end time of NDPA frame exchange decide when the sounding in the mmWave link starts. In some embodiments, a sector sweep stage includes two-direction sector sweep. One variant is that the sector sweep is one direction from an initiator to a responder. Another variant is that whether the sector sweep stage is one direction or two directions is decided through negotiation. In the embodiment depicted in FIG. 5, after the delay time 530, a sector sweep 540 with a number of training sequences 542-1, . . . , 542-N, where N is a positive integer, is communicated or conducted from AP2 to STA2 through the mmWave link (e.g., a 60 GHz band link) between AP2 and STA2. Subsequently, a sector sweep 550 with a number of training sequences 552-1, . . . , 552-M, where M is a positive integer, is communicated or conducted from STA2 to AP2 through the mmWave link (e.g., a 60 GHz band link) between AP2 and STA2.

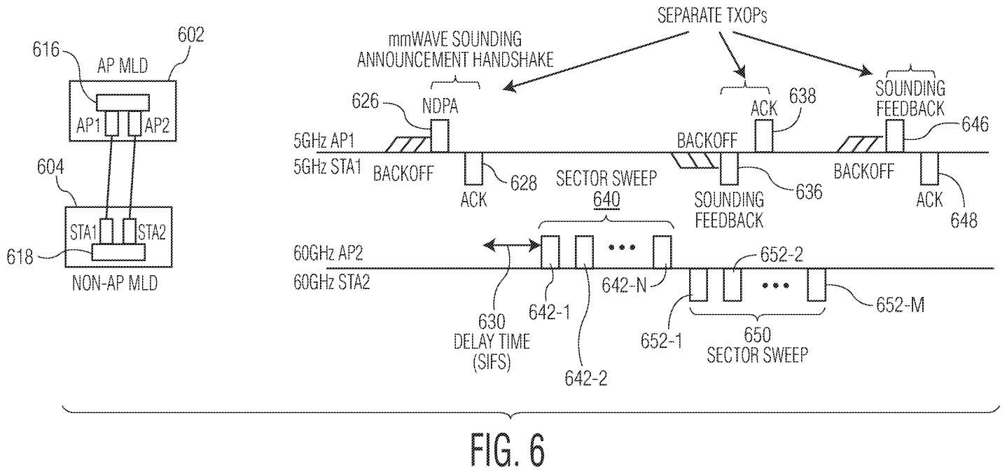

FIG. 6 depicts a frame exchange sequence of an mmWave sector sweep initiated by a non-mmWave link in accordance with an embodiment of the invention. In the embodiment depicted in FIG. 6, frames are exchanged between an AP MLD 602, which includes a common MAC controller 616 and two wireless APs AP1, AP2, and a non-AP MLD 604, which includes a common MAC controller 618 and two wireless STAs STA1, STA2. In some embodiments, the common MAC controller 616 implements upper layer MAC functionalities (e.g., beaconing, association establishment, reordering of frames, etc.) of the AP MLD 602 and a link specific part of the AP MLD 602, i.e., AP1, AP2, implements lower layer MAC functionalities (e.g., backoff, frame transmission, frame reception, etc.) of the AP MLD 602. In some embodiments, the common MAC controller 618 implements upper layer MAC functionalities (e.g., association establishment, reordering of frames, etc.) of the non-AP MLD 604 and a link specific part of the non-AP MLD 604, i.e., STA1, STA2, implements lower layer MAC functionalities (e.g., backoff, frame transmission, frame reception, etc.) of the non-AP MLD 604. The AP MLD 602 depicted in FIG. 6 is an embodiment of the AP MLD 102 depicted in FIG. 1. However, the AP MLD 102 depicted in FIG. 1 is not limited to the embodiment shown in FIG. 6. In addition, the non-AP MLD 604 depicted in FIG. 6 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 6. In the embodiment depicted in FIG. 6, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 602 is shown in FIG. 6 as including two APs, other embodiments of the AP MLD 602 may include fewer than two APs or more than two APs. In addition, although the non-AP MLD 604 is shown in FIG. 6 as including two non-AP STAs, other embodiments of the non-AP MLD 604 may include fewer than two non-AP STAs or more than two non-AP STAs. In the frame exchange sequence depicted in FIG. 6, after a backoff period (i.e., backoff counter becomes zero), AP1 transmits an NDPA 626 to STA1 through the non-mmWave link (e.g., a 5 GHz band link) between AP1 and STA1 and the NDPA 626 is acknowledged by an acknowledgement (Ack) 628 from STA1. The beamformer and the beamformee (e.g., AP2 and STA2, respectively) negotiate a delay time 630 required between the end of frame exchange of the NDPA/ACK and the start of sounding in an mmWave link (e.g., a 60 GHz band link) between AP2 and STA2. The negotiated time and the end time of NDPA frame exchange decide when the sounding in the mmWave link starts. In some embodiments, a sector sweep stage includes two-direction sector sweep. One variant is that the sector sweep is one direction from an initiator to a responder. Another variant is that whether the sector sweep stage is one direction or two directions is decided through negotiation. The sounding result (sounding feedback) may be transmitted in a non-mmWave link. The sounding feedback in an Action frame may be acknowledged by Ack. The sounding feedback may be transmitted in a separate TXOP from the sounding announcement TXOP. The sounding feedback can be initiated by a device that transmits the sounding feedback, or polled by a device that requires the sounding feedback. The sounding feedback from an initiator and a responder can be in different TXOPs, in the same TXOP (e.g., sounding feedback from the initiator, SIFS, sounding feedback from the responder; sounding feedback from the initiator, SIFS, sounding feedback from the responder, SIFS, Ack from initiator; sounding feedback from the responder, SIFS, sounding feedback from the initiator). In the embodiment depicted in FIG. 6, after the delay time 630, a sector sweep 640 with a number of training sequences 642-1, . . . , 642-N, where N is a positive integer, is communicated or conducted from AP2 to STA2 through the mmWave link (e.g., a 60 GHz band link) between AP2 and STA2. Subsequently, after a backoff period (i.e., backoff counter becomes zero), STA1 transmits a sounding feedback 636 to AP1 through the non-mmWave link (e.g., a 5 GHz band link) between AP1 and STA1 and the sounding feedback 636 is acknowledged by an acknowledgement (Ack) 638 from AP1. A sector sweep 650 with a number of training sequences 652-1, . . . , 652-M, where M is a positive integer, is communicated or conducted from STA2 to AP2 through the mmWave link (e.g., a 60 GHz band link) between AP2 and STA2. Subsequently, after a backoff period (i.e., backoff counter becomes zero), AP1 transmits a sounding feedback 646 to STA1 through the non-mmWave link (e.g., a 5 GHz band link) between AP1 and STA1 and the sounding feedback 646 is acknowledged by an acknowledgement (Ack) 648 from STA1. The NDPA 606 and the Ack 628, the sounding feedback 636 and the Ack 638, and the sounding feedback 646 and the Ack 648 may be transmitted in different TXOPs. In some embodiments, the initiator (i.e., the transmitter that initiates the NDPA) in the mmWave link decides whether it starts the sector sweep based on the medium busy/idle detected by Clear Channel Assessment (CCA) Point coordination function (PCF) Interframe Space (PIFS) before the sector sweep PPDU and by a network allocation vector (NAV) timer, while the backoff is not considered. In some embodiments, the medium being idle within the whole delay time is the condition that the initiator starts the sector sweep. With the agreed delay time 630, the beamformee knows the exactly the start time of the sector sweep 640.

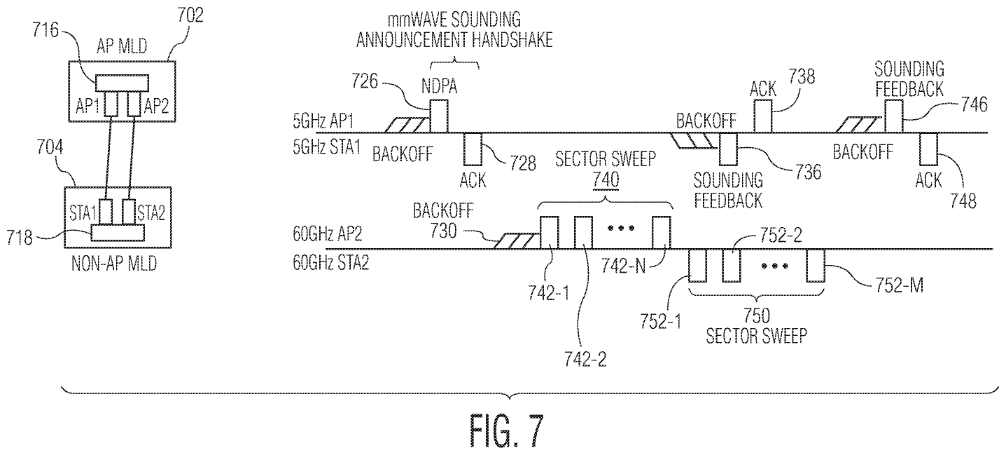

FIG. 7 depicts a frame exchange sequence of an mmWave sector sweep initiated by a non-mmWave link in accordance with an embodiment of the invention. In the embodiment depicted in FIG. 7, frames are exchanged between an AP MLD 702, which includes a common MAC controller 716 and two wireless APs AP1, AP2, and a non-AP MLD 704, which includes a common MAC controller 718 and two wireless STAs STA1, STA2. In some embodiments, the common MAC controller 716 implements upper layer MAC functionalities (e.g., beaconing, association establishment, reordering of frames, etc.) of the AP MLD 702 and a link specific part of the AP MLD 702, i.e., AP1, AP2, implements lower layer MAC functionalities (e.g., backoff, frame transmission, frame reception, etc.) of the AP MLD 702. In some embodiments, the common MAC controller 718 implements upper layer MAC functionalities (e.g., association establishment, reordering of frames, etc.) of the non-AP MLD 704 and a link specific part of the non-AP MLD 704, i.e., STA1, STA2, implements lower layer MAC functionalities (e.g., backoff, frame transmission, frame reception, etc.) of the non-AP MLD 704. The AP MLD 702 depicted in FIG. 7 is an embodiment of the AP MLD 102 depicted in FIG. 1. However, the AP MLD 102 depicted in FIG. 1 is not limited to the embodiment shown in FIG. 7. In addition, the non-AP MLD 704 depicted in FIG. 7 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 7. In the embodiment depicted in FIG. 7, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 702 is shown in FIG. 7 as including two APs, other embodiments of the AP MLD 702 may include fewer than two APs or more than two APs. In addition, although the non-AP MLD 704 is shown in FIG. 7 as including two non-AP STAs, other embodiments of the non-AP MLD 704 may include fewer than two non-AP STAs or more than two non-AP STAs. In the frame exchange sequence depicted in FIG. 7, the initiator (the transmitter of initiating an NDPA) in an mmWave link starts the sector sweep after a backoff period in the mmWave link. Specifically, after a backoff period expires (i.e., backoff counter becomes zero), AP1 transmits an NDPA 726 to STA1 through the non-mmWave link (e.g., a 5 GHz band link) between AP1 and STA1 and the NDPA 726 is acknowledged by an acknowledgement (Ack) 728 from STA1. Instead of a fixed delay time, a backoff procedure is done in the mmWave link between the end of NDPA/Ack exchange on the non-mmWave link and the start of the sector sweep on the mmWave link. After a backoff period 730 expires (i.e., becomes zero), a sector sweep 740 with a number of training sequences 742-1, . . . , 742-N, where N is a positive integer, is communicated or conducted from AP2 to STA2 through the mmWave link (e.g., a 60 GHz band link) between AP2 and STA2. Subsequently, after a backoff period expires (i.e., backoff counter becomes zero), STA1 transmits a sounding feedback 736 to AP1 through the non-mmWave link (e.g., a 5 GHz band link) between AP1 and STA1 and the sounding feedback 736 is acknowledged by an acknowledgement (Ack) 738 from AP1. A sector sweep 750 with a number of training sequences 752-1, . . . , 752-M, where M is a positive integer, is communicated or conducted from STA2 to AP2 through the mmWave link (e.g., a 60 GHz band link) between AP2 and STA2. Subsequently, after a backoff period expires (i.e., backoff counter becomes zero), AP1 transmits a sounding feedback 746 to STA1 through the non-mmWave link (e.g., a 5 GHz band link) between AP1 and STA1 and the sounding feedback 746 is acknowledged by an acknowledgement (Ack) 748 from STA1. With the backoff period 730, the beamformee STA2 does not know the exact start time of the sector sweep 740.

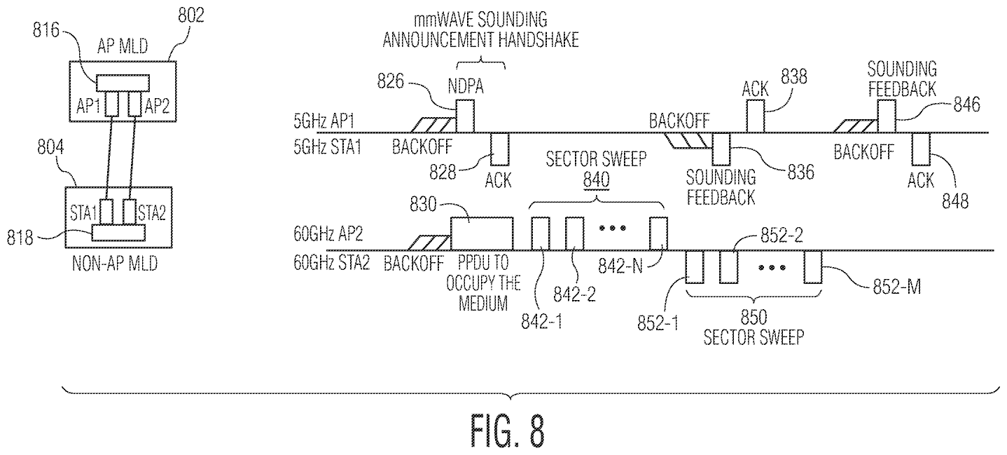

FIG. 8 depicts a frame exchange sequence of an mmWave sector sweep initiated by a non-mmWave link in accordance with an embodiment of the invention. In the embodiment depicted in FIG. 8, frames are exchanged between an AP MLD 802, which includes a common MAC controller 816 and two wireless APs AP1, AP2, and a non-AP MLD 804, which includes a common MAC controller 818 and two wireless STAs STA1, STA2. In some embodiments, the common MAC controller 816 implements upper layer MAC functionalities (e.g., beaconing, association establishment, reordering of frames, etc.) of the AP MLD 802 and a link specific part of the AP MLD 802, i.e., AP1, AP2, implements lower layer MAC functionalities (e.g., backoff, frame transmission, frame reception, etc.) of the AP MLD 802. In some embodiments, the common MAC controller 818 implements upper layer MAC functionalities (e.g., association establishment, reordering of frames, etc.) of the non-AP MLD 804 and a link specific part of the non-AP MLD 804, i.e., STA1, STA2, implements lower layer MAC functionalities (e.g., backoff, frame transmission, frame reception, etc.) of the non-AP MLD 804. The AP MLD 802 depicted in FIG. 8 is an embodiment of the AP MLD 102 depicted in FIG. 1. However, the AP MLD 102 depicted in FIG. 1 is not limited to the embodiment shown in FIG. 8. In addition, the non-AP MLD 804 depicted in FIG. 8 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 8. In the embodiment depicted in FIG. 8, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 802 is shown in FIG. 8 as including two APs, other embodiments of the AP MLD 802 may include fewer than two APs or more than two APs. In addition, although the non-AP MLD 804 is shown in FIG. 8 as including two non-AP STAs, other embodiments of the non-AP MLD 804 may include fewer than two non-AP STAs or more than two non-AP STAs. In the frame exchange sequence depicted in FIG. 8, if an initiator has backoff counters that become zero in both an mmWave link and a non-mmWave link (e.g., the backoff counter of one link may become 0 and wait for another link's backoff counter being 0), the initiator transmits an NDPA to initiate the NDPA transmission. Specifically, after a backoff period of a non-mmWave link (e.g., a 5 GHz band link) between AP1 and STA1 and a backoff period of the mmWave link (e.g., a 5 GHz band link) between AP2 and STA2 expire (i.e., become zero), AP1 transmits an NDPA 826 to STA1 through the non-mmWave link (e.g., a 5 GHz band link) between AP1 and STA1 and the NDPA 726 is acknowledged by an acknowledgement (Ack) 728 from STA1, while AP2 transmits a PPDU 830 to occupy the medium through the mmWave link (e.g., a 60 GHz band link) between AP2 and STA2. Subsequently, a sector sweep 840 with a number of training sequences 842-1, . . . , 842-N, where N is a positive integer, is communicated or conducted from AP2 to STA2 through the mmWave link (e.g., a 60 GHz band link) between AP2 and STA2. Subsequently, after a backoff period expires (i.e., backoff counter becomes zero), STA1 transmits a sounding feedback 836 to AP1 through the non-mmWave link (e.g., a 5 GHz band link) between AP1 and STA1 and the sounding feedback 836 is acknowledged by an acknowledgement (Ack) 838 from AP1. A sector sweep 850 with a number of training sequences 852-1, . . . , 852-M, where M is a positive integer, is communicated or conducted from STA2 to AP2 through the mmWave link (e.g., a 60 GHz band link) between AP2 and STA2. Subsequently, after a backoff period expires (i.e., backoff counter becomes zero), AP1 transmits a sounding feedback 846 to STA1 through the non-mmWave link (e.g., a 5 GHz band link) between AP1 and STA1 and the sounding feedback 846 is acknowledged by an acknowledgement (Ack) 848 from STA1.

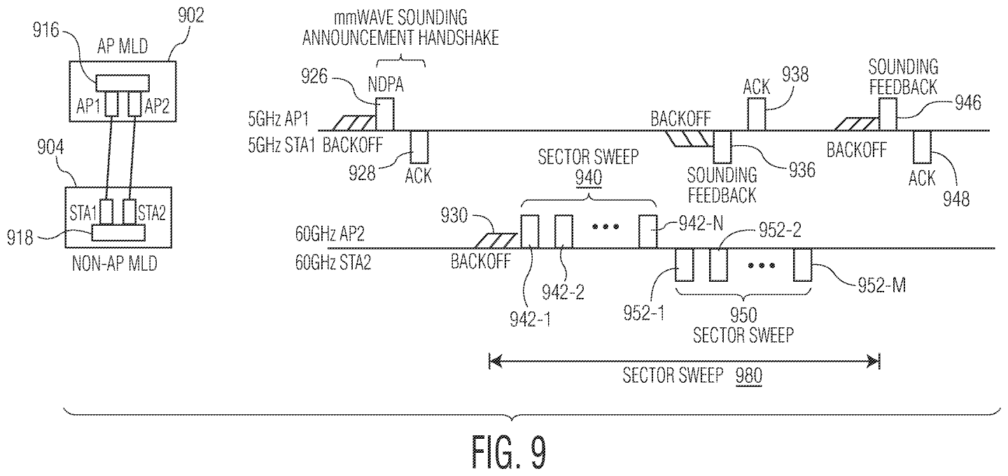

FIG. 9 depicts a frame exchange sequence of an mmWave sector sweep initiated by a non-mmWave link in accordance with an embodiment of the invention. In the embodiment depicted in FIG. 9, frames are exchanged between an AP MLD 902, which includes a common MAC controller 916 and two wireless APs AP1, AP2, and a non-AP MLD 904, which includes a common MAC controller 918 and two wireless STAs STA1, STA2. In some embodiments, the common MAC controller 916 implements upper layer MAC functionalities (e.g., beaconing, association establishment, reordering of frames, etc.) of the AP MLD 902 and a link specific part of the AP MLD 902, i.e., AP1, AP2, implements lower layer MAC functionalities (e.g., backoff, frame transmission, frame reception, etc.) of the AP MLD 902. In some embodiments, the common MAC controller 918 implements upper layer MAC functionalities (e.g., association establishment, reordering of frames, etc.) of the non-AP MLD 904 and a link specific part of the non-AP MLD 904, i.e., STA1, STA2, implements lower layer MAC functionalities (e.g., backoff, frame transmission, frame reception, etc.) of the non-AP MLD 904. The AP MLD 902 depicted in FIG. 9 is an embodiment of the AP MLD 102 depicted in FIG. 1. However, the AP MLD 102 depicted in FIG. 1 is not limited to the embodiment shown in FIG. 9. In addition, the non-AP MLD 904 depicted in FIG. 9 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 9. In the embodiment depicted in FIG. 9, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 902 is shown in FIG. 9 as including two APs, other embodiments of the AP MLD 902 may include fewer than two APs or more than two APs. In addition, although the non-AP MLD 904 is shown in FIG. 9 as including two non-AP STAs, other embodiments of the non-AP MLD 904 may include fewer than two non-AP STAs or more than two non-AP STAs. In the frame exchange sequence depicted in FIG. 9, an NDPA can announce that a following established TWT Service Period (SP) is used for sounding and a responder waits for an initiator's sector sweep PPDUs in the indicated TWT SP. Specifically, after a backoff period expires (i.e., backoff counter becomes zero), AP1 transmits an NDPA 926 to STA1 through the non-mmWave link (e.g., a 5 GHz band link) between AP1 and STA1 to announce that a following established TWT SP 980 is used for sounding and the non-AP MLD 904 waits for the AP MLD 902's sector sweep PPDUs in the indicated TWT SP. The NDPA 926 is acknowledged by an acknowledgement (Ack) 928 from STA1. With the TWT SP 980, after a backoff period 930 expires (i.e., backoff counter becomes zero), a sector sweep 940 with a number of training sequences 942-1, . . . , 942-N, where N is a positive integer, is communicated or conducted from AP2 to STA2 through the mmWave link (e.g., a 60 GHz band link) between AP2 and STA2. Subsequently, after a backoff period expires (i.e., backoff counter becomes zero), STA1 transmits a sounding feedback 936 to AP1 through the non-mmWave link (e.g., a 5 GHz band link) between AP1 and STA1 and the sounding feedback 936 is acknowledged by an acknowledgement (Ack) 938 from AP1. A sector sweep 950 with a number of training sequences 952-1, . . . , 952-M, where M is a positive integer, is communicated or conducted from STA2 to AP2 through the mmWave link (e.g., a 60 GHz band link) between AP2 and STA2. Subsequently, after a backoff period expires (i.e., backoff counter becomes zero), AP1 transmits a sounding feedback 946 to STA1 through the non-mmWave link (e.g., a 5 GHz band link) between AP1 and STA1 and the sounding feedback 946 is acknowledged by an acknowledgement (Ack) 948 from STA1.

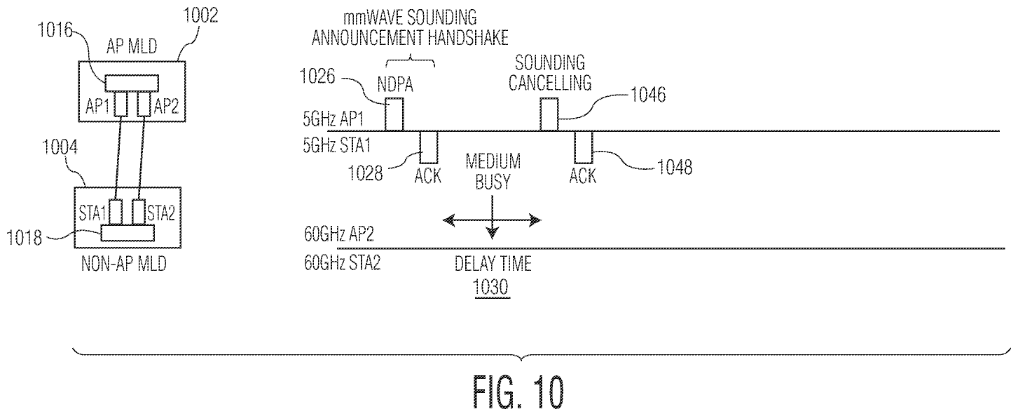

FIG. 10 depicts a frame exchange sequence of an mmWave sector sweep initiated by a non-mmWave link in accordance with an embodiment of the invention. In the embodiment depicted in FIG. 10, frames are exchanged between an AP MLD 1002, which includes a common MAC controller 1016 and two wireless APs AP1, AP2, and a non-AP MLD 1004, which includes a common MAC controller 1018 and two wireless STAs STA1, STA2. In some embodiments, the common MAC controller 1016 implements upper layer MAC functionalities (e.g., beaconing, association establishment, reordering of frames, etc.) of the AP MLD 1002 and a link specific part of the AP MLD 1002, i.e., AP1, AP2, implements lower layer MAC functionalities (e.g., backoff, frame transmission, frame reception, etc.) of the AP MLD 1002. In some embodiments, the common MAC controller 1018 implements upper layer MAC functionalities (e.g., association establishment, reordering of frames, etc.) of the non-AP MLD 1004 and a link specific part of the non-AP MLD 1004, i.e., STA1, STA2, implements lower layer MAC functionalities (e.g., backoff, frame transmission, frame reception, etc.) of the non-AP MLD 1004. The AP MLD 1002 depicted in FIG. 10 is an embodiment of the AP MLD 102 depicted in FIG. 1. However, the AP MLD 102 depicted in FIG. 1 is not limited to the embodiment shown in FIG. 10. In addition, the non-AP MLD 1004 depicted in FIG. 10 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 10. In the embodiment depicted in FIG. 10, an mmWave link (e.g., a 45 GHz link or a 60 GHz link) is between AP2 and STA2, which both operate in an mmWave frequency band (e.g., a 45 GHz or 60 GHz frequency band) and are capable of mmWave communications, and a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications. Although the AP MLD 1002 is shown in FIG. 10 as including two APs, other embodiments of the AP MLD 1002 may include fewer than two APs or more than two APs. In addition, although the non-AP MLD 1004 is shown in FIG. 10 as including two non-AP STAs, other embodiments of the non-AP MLD 1004 may include fewer than two non-AP STAs or more than two non-AP STAs. In the frame exchange sequence depicted in FIG. 10, an initiator in a non-mmWave link may cancel the sounding when it cannot perform a sector sweep. Specifically, AP1 transmits an NDPA 1026 to STA1 through the non-mmWave link (e.g., a 5 GHz band link) between AP1 and STA1 and the NDPA 1026 is acknowledged by an acknowledgement (Ack) 1028 from STA1. After a delay time 1030, the medium (e.g., the mmWave link (e.g., a GHz link or a 60 GHz link) between AP2 and STA2) is busy and the AP MLD 1002 cancels the sounding when the AP MLD 1002 cannot perform a sector sweep. Specifically, AP1 transmits a sounding canceling message 1046 to STA1 through the non-mmWave link (e.g., a 5 GHz band link) between AP1 and STA1 and the sounding canceling message 1046 is acknowledged by an acknowledgement (Ack) 1048 from STA1.

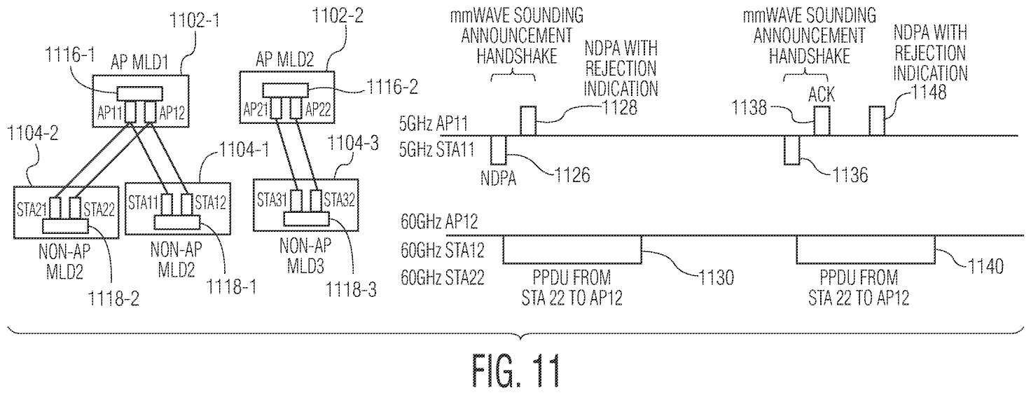

FIG. 11 depicts a frame exchange sequence of sounding rejection by a responder in accordance with an embodiment of the invention. In the embodiment depicted in FIG. 11, frames are exchanged between an AP MLD 1102-1, which includes a common MAC controller 1116-1 and two wireless APs AP11, AP12, an AP MLD 1102-2, which includes a common MAC controller 1116-2 and two wireless APs AP21, AP22, a non-AP MLD 1104-1, which includes a common MAC controller 1118-1 and two wireless STAs STA11, STA12, a non-AP MLD 1104-2, which includes a common MAC controller 1118-2 and two wireless STAs STA21, STA22, and a non-AP MLD 1104-3, which includes a common MAC controller 1118-3 and two wireless STAs STA31, STA32. In some embodiments, the common MAC controller 1116-1 implements upper layer MAC functionalities (e.g., beaconing, association establishment, reordering of frames, etc.) of the AP MLD 1102-1 and a link specific part of the AP MLD 1102-1, i.e., AP11, AP12, implements lower layer MAC functionalities (e.g., backoff, frame transmission, frame reception, etc.) of the AP MLD 1102-1. In some embodiments, the common MAC controller 1116-2 implements upper layer MAC functionalities (e.g., beaconing, association establishment, reordering of frames, etc.) of the AP MLD 1102-2 and a link specific part of the AP MLD 1102-1, i.e., AP21, AP12, implements lower layer MAC functionalities (e.g., backoff, frame transmission, frame reception, etc.) of the AP MLD 1102-2. In some embodiments, the common MAC controller 1118-1 implements upper layer MAC functionalities (e.g., association establishment, reordering of frames, etc.) of the non-AP MLD 1104-1 and a link specific part of the non-AP MLD 1104-1, i.e., STA11, STA12, implements lower layer MAC functionalities (e.g., backoff, frame transmission, frame reception, etc.) of the non-AP MLD 1104-1. In some embodiments, the common MAC controller 1118-2 implements upper layer MAC functionalities (e.g., association establishment, reordering of frames, etc.) of the non-AP MLD 1104-2 and a link specific part of the non-AP MLD 1104-2, i.e., STA21, STA22, implements lower layer MAC functionalities (e.g., backoff, frame transmission, frame reception, etc.) of the non-AP MLD 1104-2. In some embodiments, the common MAC controller 1118-3 implements upper layer MAC functionalities (e.g., beaconing, association establishment, reordering of frames, etc.) of the non-AP MLD 1104-3 and a link specific part of the non-AP MLD 1104-3, i.e., STA31, STA32, implements lower layer MAC functionalities (e.g., backoff, frame transmission, frame reception, etc.) of the non-AP MLD 1104-3. The AP MLDs 1102-1, 1102-2 depicted in FIG. 11 are embodiments of the AP MLD 102 depicted in FIG. 1. However, the AP MLD 102 depicted in FIG. 1 is not limited to the embodiment shown in FIG. 11. In addition, the non-AP MLDs 1104-1, 1104-2, 1104-3 depicted in FIG. 11 are embodiments of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 11. In the embodiment depicted in FIG. 11, an mmWave link (e.g., a 45 GHz link or a 60 GHz link) is between AP12 and STA12, which both operate in an mmWave frequency band (e.g., a 45 GHz or 60 GHz frequency band) and are capable of mmWave communications, an mmWave link (e.g., a 45 GHz link or a 60 GHz link) is between AP12 and STA22, which both operate in an mmWave frequency band (e.g., a 45 GHz or 60 GHz frequency band) and are capable of mmWave communications, and an mmWave link (e.g., a 45 GHz link or a 60 GHz link) is between AP22 and STA32, which both operate in an mmWave frequency band (e.g., a 45 GHz or 60 GHz frequency band) and are capable of mmWave communications. A non-mmWave link (e.g., a 2.4/5/6 GHz band link) is between AP11 and STA11, which both operate in a non-mmWave frequency band (e.g., a 2.4 GHz, 5 GHz, or 6 GHz frequency band) and are capable of non-mmWave communications, a non-mmWave link (e.g., a 2.4/5/6 GHz band link) is between AP11 and STA21, which both operate in a non-mmWave frequency band (e.g., a 2.4 GHz, 5 GHz, or 6 GHz frequency band) and are capable of non-mmWave communications, and a non-mmWave link (e.g., a 2.4/5/6 GHz band link) is between AP21 and STA31, which both operate in a non-mmWave frequency band (e.g., a 2.4 GHz, 5 GHz, or 6 GHz frequency band) and are capable of non-mmWave communications. Although the AP MLD 1102-1 or 1102-2 is shown in FIG. 11 as including two APs, other embodiments of the AP MLDs 1102-1, 1102-2 may include fewer than two APs or more than two APs. In addition, although the non-AP MLD 1104-1, 1104-2, or 1104-3 is shown in FIG. 11 as including two non-AP STAs, other embodiments of the non-AP MLDs 1104-1, 1104-2, 1104-3 may include fewer than two non-AP STAs or more than two non-AP STAs. In the frame exchange sequence depicted in FIG. 11, mmWave sounding is initiated by a non-mmWave link, and sounding rejection is performed by a responder. The responder may be busy in an mmWave link when a sounding request is received from an initiator. The responder may reject the request of mmWave link sounding. The rejection can be a responding frame of the handshake or be transmitted later. Specifically, STA11 transmits an NDPA 1126 to AP11 through the non-mmWave link (e.g., a 5 GHz band link) between STA11 and AP11. However, the mmWave medium is busy, for example, STA22 transmitting a PPDU 1130 to AP12 through the mmWave link (e.g., a 45 GHz link or a 60 GHz link) between STA22 and AP12. Consequently, AP11 transmits an NDPA 1128 with rejection indication to STA11 through the non-mmWave link (e.g., a 5 GHz band link) between STA11 and AP11. Subsequently, STA11 transmits an NDPA 1136 to AP11 through the non-mmWave link (e.g., a 5 GHz band link) between STA11 and AP11 and the NDPA 1136 is acknowledged by an acknowledgement (Ack) 1138 from AP11. However, the mmWave medium is busy, for example, STA22 transmitting a PPDU 1140 to AP12 through an mmWave link (e.g., a 45 GHz link or a 60 GHz link) between STA22 and AP12. Consequently, AP11 transmits an NDPA 1148 with rejection indication to STA11 through the non-mmWave link (e.g., a 5 GHz band link) between STA11 and AP11.

Some examples of beam refinement of an mmWave link are described as follows. In a first option, beam refinement is performed in an mmWave link without the help of a non-mmWave link. In a second option, beam refinement is initiated by a non-mmWave link. The beam refinement frame exchange sequences include the beam refinement announcement from device 1 to device 2, SIFS, Ack from device 2 to device 1, SIFS (or other IFS that can be figured out by both sides correctly), beam refining. The IFS can be acquired through backoff.

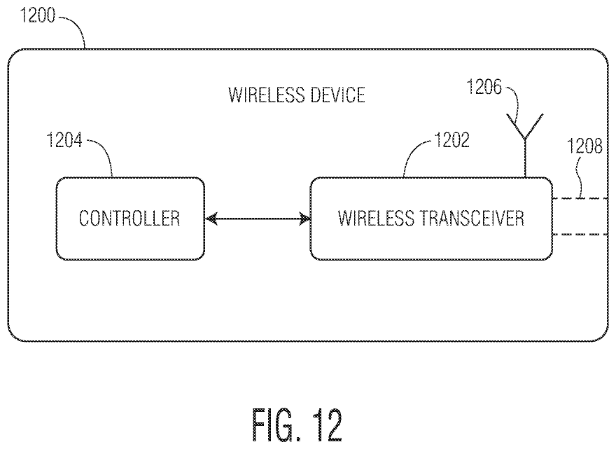

FIG. 12 depicts a wireless device 1200 in accordance with an embodiment of the invention. The wireless device 1200 can be used in the multi-link communications system 100 depicted in FIG. 1. For example, the wireless device 1200 may be an embodiment of the APs 110-1, 110-2, 110-3 or the STAs 120-1, 120-2, 120-3 depicted in FIG. 1, the APs AP1, AP2 or the STAs STA1, STA2 depicted in FIG. 3, the APs AP1, AP2 or the STAs STA1, STA2 depicted in FIG. 4, the APs AP1, AP2 or the STAs STA1, STA2 depicted in FIG. 5, the APs AP1, AP2 or the STAs STA1, STA2 depicted in FIG. 6, the APs AP1, AP2 or the STAs STA1, STA2 depicted in FIG. 7, the APs AP1, AP2 or the STAs STA1, STA2 depicted in FIG. 8, the APs AP1, AP2 or the STAs STA1, STA2 depicted in FIG. 9, the APs AP1, AP2 or the STAs STA1, STA2 depicted in FIG. 10, and/or the APs AP11, AP12, AP21, AP22 or the STAs STA11, STA12, STA21, STA22, STA31, STA32 depicted in FIG. 11. However, the APs 110-1, 110-2, 110-3 or the STAs 120-1, 120-2, 120-3 depicted in FIG. 1, the APs AP1, AP2 or the STAs STA1, STA2 depicted in FIG. 3, the APs AP1, AP2 or the STAs STA1, STA2 depicted in FIG. 4, the APs AP1, AP2 or the STAs STA1, STA2 depicted in FIG. 5, the APs AP1, AP2 or the STAs STA1, STA2 depicted in FIG. 6, the APs AP1, AP2 or the STAs STA1, STA2 depicted in FIG. 7, the APs AP1, AP2 or the STAs STA1, STA2 depicted in FIG. 8, the APs AP1, AP2 or the STAs STA1, STA2 depicted in FIG. 9, the APs AP1, AP2 or the STAs STA1, STA2 depicted in FIG. 10, and/or the APs AP11, AP12, AP21, AP22 or the STAs STA11, STA12, STA21, STA22, STA31, STA32 depicted in FIG. 11 are not limited to the embodiment depicted in FIG. 12. In the embodiment depicted in FIG. 12, the wireless device 1200 includes a wireless transceiver 1202, a controller 1204 operably connected to the wireless transceiver, and at least one antenna 1206 operably connected to the wireless transceiver. In some embodiments, the wireless device 1200 may include at least one optional network port 1208 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1200 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 1200 may be compatible with an IEEE 802.11 protocol.

In accordance with an embodiment of the invention, the controller 1204 is configured to generate control or management information regarding a millimeter wave (mmWave) link between a wireless MLD to which the wireless device 1200 belongs and a second wireless MLD and the wireless transceiver 1202 is configured to transmit the control or management information regarding the mmWave link to the second wireless MLD through the mmWave link or a non-mmWave link between the wireless MLD to which the wireless device 1200 belongs and the second wireless MLD. In some embodiments, the wireless MLD includes an access point (AP) MLD that includes a wireless AP, the wireless AP includes the controller and the wireless transceiver, and the second wireless MLD includes a non-AP MLD that includes a non-AP station (STA). In some embodiments, the non-mmWave link includes one of a 2.4 Gigahertz (GHz) link, a 5 GHz link, or a 6 GHz link, and the mmWave link includes a 45 GHz link or a 60 GHz link. In some embodiments, the wireless transceiver is further configured to transmit the control or management information regarding the mmWave link to the second wireless MLD through the non-mmWave link between the wireless MLD to which the wireless device 1200 belongs and the second wireless MLD. In some embodiments, the controller is further configured to generate a broadcast frame that contains the control or management information regarding the mmWave link, and the wireless transceiver is further configured to transmit the broadcast frame to the second wireless MLD through the non-mmWave link between the wireless MLD to which the wireless device 1200 belongs and the second wireless MLD. In some embodiments, the control or management information regarding the mmWave link includes link connection establishment information regarding the mmWave link. In some embodiments, the control or management information regarding the mmWave link includes mmWave sounding announcement information regarding the mmWave link that initiates a sector sweep training between the wireless MLD to which the wireless device 1200 belongs and the second wireless MLD. In some embodiments, the mmWave sounding announcement information regarding the mmWave link includes a null data packet announcement (NDPA) or a request to send (RTS). In some embodiments, the wireless transceiver is further configured to transmit the control or management information regarding the mmWave link to the second wireless MLD through the mmWave link between the wireless MLD and the second wireless MLD. In some embodiments, the control or management information regarding the mmWave link includes a measurement related frame of the mmWave link. In some embodiments, the controller is further configured to generate a unicast frame that contains the control or management information regarding the mmWave link, and the wireless transceiver is further configured to transmit the unicast frame through the mmWave link. In some embodiments, the wireless MLD includes a non-access point (AP) MLD that includes a non-AP station (STA), and the non-AP station includes the controller and the wireless transceiver, and the second wireless MLD includes an AP MLD that includes a wireless AP. In some embodiments, the wireless MLD is compatible with an Institute of Electrical and Electronics Engineers (IEEE) 802.11 protocol.

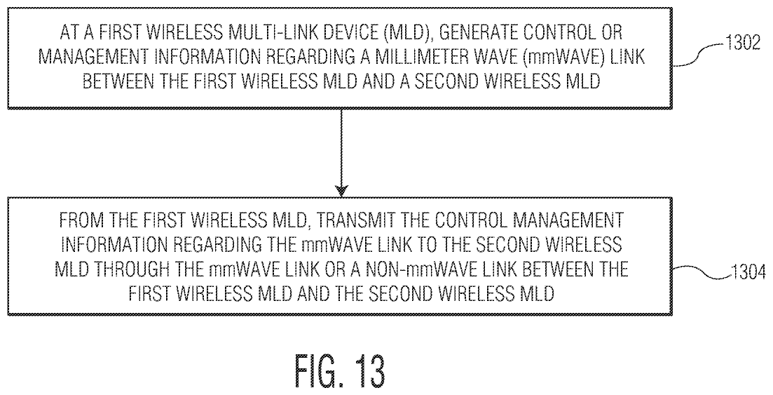

FIG. 13 is a process flow diagram of a method for wireless communications in accordance with an embodiment of the invention. At block 1302, at a first wireless multi-link device (MLD), control or management information regarding a millimeter wave (mmWave) link between the first wireless MLD and a second wireless MLD is generated. At block 1304, from the first wireless MLD, the control or management information regarding the mmWave link is transmitted to the second wireless MLD through the mmWave link or a non-mmWave link between the first wireless MLD and the second wireless MLD. In some embodiments, the first wireless MLD includes an access point (AP) MLD that includes a wireless AP, and the second wireless MLD includes a non-AP MLD that includes a non-AP station (STA). In some embodiments, the non-mmWave link includes one of a 2.4 Gigahertz (GHz) link, a 5 GHz link, or a 6 GHz link, and the mmWave link includes a 45 GHz link or a 60 GHz link. In some embodiments, the control or management information regarding the mmWave link is transmitted to the second wireless MLD through the non-mmWave link between the first wireless MLD and the second wireless MLD. In some embodiments, at the first wireless MLD, a broadcast frame that contains the control or management information regarding the mmWave link is generated, and from the first wireless MLD, the broadcast frame is transmitted to the second wireless MLD through the non-mmWave link between the first wireless MLD and the second wireless MLD. In some embodiments, the control or management information regarding the mmWave link includes link connection establishment information regarding the mmWave link. In some embodiments, the control or management information regarding the mmWave link includes mmWave sounding announcement information regarding the mmWave link that initiates a sector sweep training between the first wireless MLD and the second wireless MLD. In some embodiments, the mmWave sounding announcement information regarding the mmWave link includes a null data packet announcement (NDPA) or a request to send (RTS). In some embodiments, from the first wireless MLD, the control or management information regarding the mmWave link is transmitted to the second wireless MLD through the mmWave link between the first wireless MLD and the second wireless MLD. In some embodiments, the control or management information regarding the mmWave link includes a measurement related frame of the mmWave link. In some embodiments, at the first wireless MLD, a unicast frame that contains the control or management information regarding the mmWave link is generated, and from the first wireless MLD, the unicast frame is transmitted through the mmWave link. In some embodiments, the first wireless MLD includes a non-AP MLD that includes a non-AP station (STA), the non-AP station includes the controller and the wireless transceiver, and the second wireless MLD includes an AP MLD that includes a wireless AP. In some embodiments, the first wireless MLD is compatible with an Institute of Electrical and Electronics Engineers (IEEE) 802.11 protocol. The first wireless MLD may be the same as or similar to the AP MLD 102 depicted in FIG. 1, the non-AP MLD 104-1, 104-2, or 104-3 depicted in FIG. 1, the AP MLD 302 depicted in FIG. 3, the non-AP MLD 304 depicted in FIG. 3, the AP MLD 402 depicted in FIG. 4, the non-AP MLD 404 depicted in FIG. 4, the AP MLD 502 depicted in FIG. 5, the non-AP MLD 504 depicted in FIG. 5, the AP MLD 602 depicted in FIG. 6, the non-AP MLD 604 depicted in FIG. 6, the AP MLD 702 depicted in FIG. 7, the non-AP MLD 704 depicted in FIG. 7, the AP MLD 802 depicted in FIG. 8, the non-AP MLD 804 depicted in FIG. 8, the AP MLD 902 depicted in FIG. 9, the non-AP MLD 904 depicted in FIG. 9, the AP MLD 1002 depicted in FIG. 10, the non-AP MLD 1004 depicted in FIG. 10, the AP MLD 1102-1 or 1102-2 depicted in FIG. 11, and/or the non-AP MLD 1104-1, 1104-2, or 1104-3 depicted in FIG. 11. The second wireless MLD may be the same as or similar to the AP MLD 102 depicted in FIG. 1, the non-AP MLD 104-1, 104-2, or 104-3 depicted in FIG. 1, the AP MLD 302 depicted in FIG. 3, the non-AP MLD 304 depicted in FIG. 3, the AP MLD 402 depicted in FIG. 4, the non-AP MLD 404 depicted in FIG. 4, the AP MLD 502 depicted in FIG. 5, the non-AP MLD 504 depicted in FIG. 5, the AP MLD 602 depicted in FIG. 6, the non-AP MLD 604 depicted in FIG. 6, the AP MLD 702 depicted in FIG. 7, the non-AP MLD 704 depicted in FIG. 7, the AP MLD 802 depicted in FIG. 8, the non-AP MLD 804 depicted in FIG. 8, the AP MLD 902 depicted in FIG. 9, the non-AP MLD 904 depicted in FIG. 9, the AP MLD 1002 depicted in FIG. 10, the non-AP MLD 1004 depicted in FIG. 10, the AP MLD 1102-1 or 1102-2 depicted in FIG. 11, and/or the non-AP MLD 1104-1, 1104-2, or 1104-3 depicted in FIG. 11.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless multi-link device (MLD) comprising:
a controller configured to generate control or management information regarding a millimeter wave (mmWave) link between the wireless MLD and a second wireless MLD; and
a wireless transceiver configured to transmit the control or management information regarding the mmWave link to the second wireless MLD through the mmWave link or a non-mmWave link between the wireless MLD and the second wireless MLD.

2. The wireless MLD of claim 1, wherein the wireless MLD comprises an access point (AP) MLD that comprises a wireless AP, wherein the wireless AP comprises the controller and the wireless transceiver, and wherein the second wireless MLD comprises a non-AP MLD that comprises a non-AP station (STA).

3. The wireless MLD of claim 1, wherein the non-mmWave link comprises one of a 2.4 Gigahertz (GHz) link, a 5 GHz link, or a 6 GHz link, and wherein the mmWave link comprises a 45 GHz link or a 60 GHz link.

4. The wireless MLD of claim 1, wherein the wireless transceiver is further configured to transmit the control or management information regarding the mmWave link to the second wireless MLD through the non-mmWave link between the wireless MLD and the second wireless MLD.

5. The wireless MLD of claim 4, wherein the controller is further configured to generate a broadcast frame that contains the control or management information regarding the mmWave link, and wherein the wireless transceiver is further configured to transmit the broadcast frame to the second wireless MLD through the non-mmWave link between the wireless MLD and the second wireless MLD.

6. The wireless MLD of claim 4, wherein the control or management information regarding the mmWave link comprises link connection establishment information regarding the mmWave link.

7. The wireless MLD of claim 4, wherein the control or management information regarding the mmWave link comprises mmWave sounding announcement information regarding the mmWave link that initiates a sector sweep training between the wireless MLD and the second wireless MLD.

8. The wireless MLD of claim 7, wherein the mmWave sounding announcement information regarding the mmWave link comprises a null data packet announcement (NDPA) or a request to send (RTS).

9. The wireless MLD of claim 1, wherein the wireless transceiver is further configured to transmit the control or management information regarding the mmWave link to the second wireless MLD through the mmWave link between the wireless MLD and the second wireless MLD.

10. The wireless MLD of claim 9, wherein the control or management information regarding the mmWave link comprises a measurement related frame of the mmWave link.

11. The wireless MLD of claim 9, wherein the controller is further configured to generate a unicast frame that contains the control or management information regarding the mmWave link, and wherein the wireless transceiver is further configured to transmit the unicast frame through the mmWave link.

12. The wireless MLD of claim 1, wherein the wireless MLD comprises a non-access point (AP) MLD that comprises a non-AP station (STA), wherein the non-AP station comprises the controller and the wireless transceiver, and wherein the second wireless MLD comprises an AP MLD that comprises a wireless AP.

13. The wireless MLD of claim 1, wherein the wireless MLD is compatible with an Institute of Electrical and Electronics Engineers (IEEE) 802.11 protocol.

14. A wireless access point (AP) of an AP multi-link device (MLD) comprising:
a controller configured to generate control or management information regarding a millimeter wave (mmWave) link between the AP MLD and a non-AP MLD, wherein the mmWave link comprises a 45 Gigahertz (GHz) link or a 60 GHz link; and
a wireless transceiver configured to transmit the control or management information regarding the mmWave link to the non-AP MLD through a non-mmWave link between the AP MLD and the non-AP MLD, wherein the non-mmWave link comprises one of a 2.4 GHz link, a 5 GHz link, or a 6 GHz link.

15. The wireless AP of claim 14, wherein the control or management information regarding the mmWave link comprises link connection establishment information regarding the mmWave link.

16. The wireless AP of claim 14, wherein the control or management information regarding the mmWave link comprises mmWave sounding announcement information regarding the mmWave link that initiates a sector sweep training between the AP MLD and the non-AP MLD.

17. The wireless AP of claim 16, wherein the mmWave sounding announcement information regarding the mmWave link comprises a null data packet announcement (NDPA) or a request to send (RTS).

18. The wireless AP of claim 14, wherein the wireless AP is compatible with an Institute of Electrical and Electronics Engineers (IEEE) 802.11 protocol.

19. A method for wireless communications, the method comprising:
at a first wireless multi-link device (MLD), generating control or management information regarding a millimeter wave (mmWave) link between the first wireless MLD and a second wireless MLD; and
from the first wireless MLD, transmitting the control or management information regarding the mmWave link to the second wireless MLD through the mmWave link or a non-mmWave link between the first wireless MLD and the second wireless MLD.

20. The method of claim 19, wherein the non-mmWave link comprises one of a 2.4 Gigahertz (GHz) link, a 5 GHz link, or a 6 GHz link, and wherein the mmWave link comprises a 45 GHz link or a 60 GHz link.
